(19) United States
(12) Patent Application Publication
(10) Pub. No.: US 2006/0213098 A1
(43) Pub. Date: Sep. 28, 2006

(54) Illuminated address sign

(76) Inventors: Philip Chan, San Marino, CA (US); Timothy Aiu, Chino Hills, CA (US)

Correspondence Address: WIGGIN AND DANA LLP;ATTENTION: PATENT DOCKETING, ONE CENTURY TOWER, P.O. BOX 1832, NEW HAVEN, CT, 06508-1832, US

(21) Appl. No.: 11/086,952

(22) Filed: Mar. 22, 2005

(51) Int. Cl. G09F 13/22

(52) U.S. Cl. 40/544

(57) ABSTRACT

An illuminated address sign (20) including a housing (22), a lens (24) positioned in the housing, an at least semi-transparent, flame-retardant barrier (26) positioned in the housing adjacent the lens, and an electroluminescent light source (28) positioned in the housing adjacent the barrier. Housing (22) includes a front surface (30) having an opening (32), first and second side surfaces, (34) and (36), respectively, top and bottom surfaces, (38) and (40), respectively, and an open internal cavity (42) opposite the front surface. Lens (24) includes a display side (52) and an internal side (54) with side (52) being visible through opening (32) and side (54) positioned in cavity (42). Barrier (26) includes a front side (56) and a back side (58) and is positioned in cavity (42) with side (56) in contact with side (54) of lens (24) and side (58) positioned in cavity (42). Light source (28) is positioned in cavity (42) adjacent and/or in contact with side (58) of barrier (26). A back plate (62) is joined to housing (22) to enclose lens (24), barrier (26), and light source (28) within cavity (42).

### BACKGROUND OF THE INVENTION

1. Field of the Invention

This invention relates to an illuminated address sign, and more particularly to an illuminated address sign having a flame-retardant barrier and an electroluminescent light source.

2. Description of the Related Art

Illuminated signs which are used in myriad ways, e.g., to define exits, stairwells, fire alarms, equipment-in-use, hazardous areas, commercial or residential addresses, etc. Historically, illuminated signs have been conventionally illuminated using incandescent bulbs or fluorescent tubes that operate on 110-120 volt AC current. Unfortunately, incandescent bulbs and fluorescent tube lamps have relatively short service lives, particularly if placed in dynamic conditions found in many commercial settings.

Signage having incandescent bulbs for its lighting source also has the problem of a non-uniform plane of light. The light from incandescent bulbs generally tends to concentrate in the area of the bulbs. As a result, the signs show “hot” areas or areas of greater brightness where the bulbs are positioned. In addition, incandescent bulbs often generate a significant amount of heat, which concentrates at each bulb. As a result, incandescent bulbs are often not suitable for use in locations adjacent to highly flammable materials.

### SUMMARY OF THE INVENTION

One aspect of the present invention is an illuminated address sign comprising a housing, a lens positioned in said housing, an at least semi-transparent, flame-retardant barrier positioned in said housing adjacent said lens, and an electroluminescent light source positioned in said housing adjacent said flame-retardant barrier so as to sandwich said flame-retardant barrier between said lens and said electroluminescent light source.

Another aspect of the present invention is an illuminated address sign comprising a housing including a front surface having an opening, first and second side surfaces, top and bottom surfaces, and an internal cavity opposite said front surface, a lens including a display side and an internal side, said lens sized to cover said opening, said display side being exposed through said opening, and said internal side positioned in said internal cavity, an at least semi-transparent flame-retardant barrier having a front side and a back side, said barrier positioned in said internal cavity and sized to cover said lens, said front side in contact with said internal side and said back side and said back side positioned in said internal cavity, an electroluminescent light source positioned in said internal cavity adjacent said back side and sized to cover said lens, said light source including wires for connecting to a power source, and a back plate removably joined to said housing to enclose said lens, said flame-retardant barrier, and said electroluminescent light source within said internal cavity.

Still another aspect of the present invention is an illuminated address sign comprising a housing, a lens positioned in said housing, an at least semi-transparent flame-retardant barrier, said barrier positioned in said housing adjacent said lens, means for providing a non-refractive, uniform plane of light, said means positioned in said housing adjacent said flame-retardant barrier so as to sandwich said flame-retardant barrier between said lens and said means for providing a non-refractive, uniform plane of light, and a back plate removably joined to said housing to enclose said lens, said flame-retardant barrier, and said means for providing a non-refractive, uniform plane of light within said housing.

### BRIEF DESCRIPTION OF THE DRAWINGS

For the purpose of illustrating the invention, the drawings show a form of the invention that is presently preferred. However, it should be understood that the present invention is not limited to the precise arrangements and instrumentalities shown in the drawings, wherein:

FIG. 1 is a front-isometric view an address sign according to one embodiment of the present invention;

FIG. 2 is a front-oriented exploded view of the address sign illustrated in FIG. 1;

FIG. 3 is a rear-oriented exploded view of the address sign illustrated in FIGS. 1 and 2; and

FIG. 4 is a partial section view taken along line 4-4 of FIG. 1.

### DETAILED DESCRIPTION

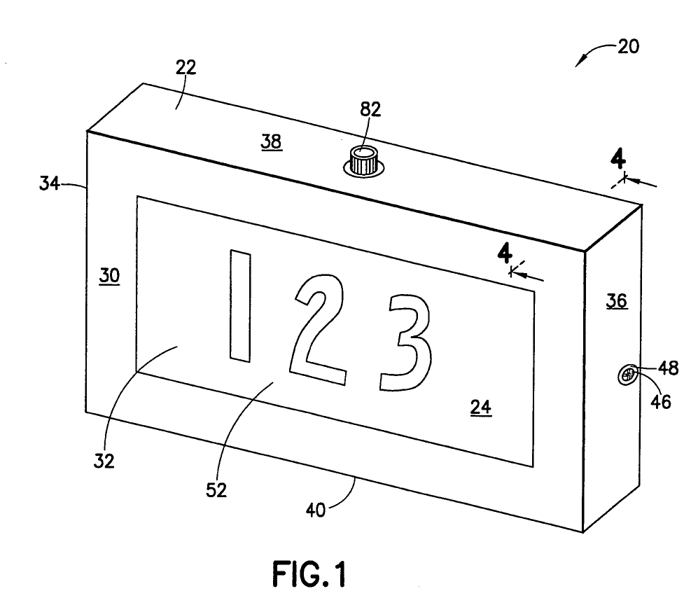

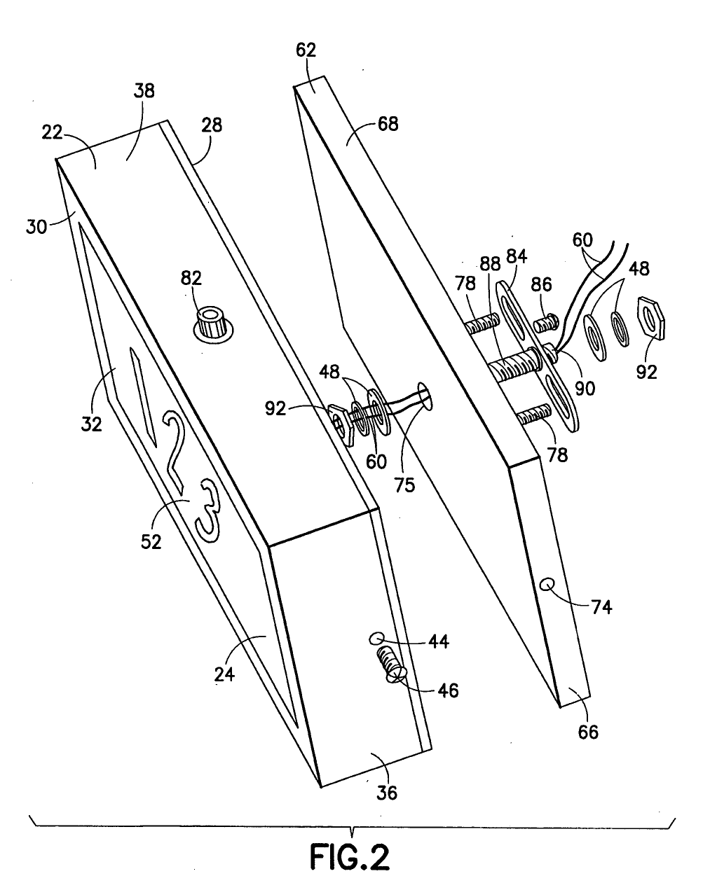

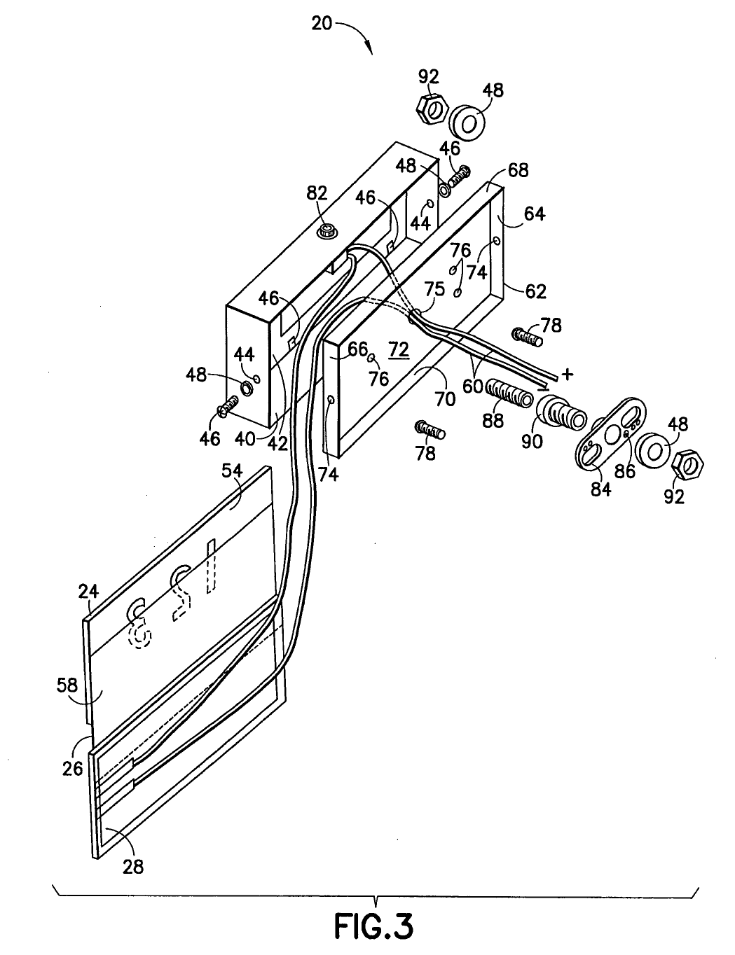

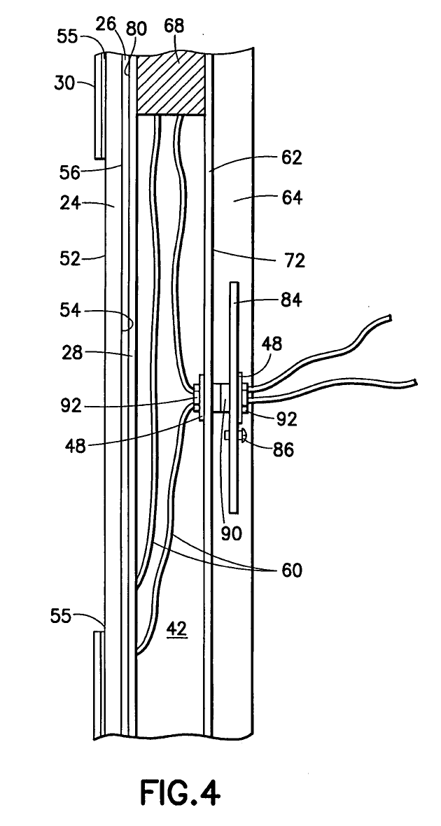

Referring now to FIGS. 1-4 in which like reference numerals indicate like parts, one embodiment of the present invention includes an illuminated address sign 20 including a housing 22, a lens 24 positioned in the housing, an at least semi-transparent, flame-retardant barrier 26 positioned in the housing adjacent the lens, and an electroluminescent light source 28 (referred to hereinafter as EL light source 28) positioned in the housing adjacent the barrier so as to sandwich the barrier between the lens and the electroluminescent light source.

Housing 22 is generally an open box-like construction and includes a front surface 30 having an opening 32, first and second side surfaces, 34 and 36, respectively, top and bottom surfaces, 38 and 40, respectively, and an open internal cavity 42 opposite the front surface. First and second side surfaces, 34 and 36, respectively, typically have screw holes 44 approximately mid-way between top and bottom surfaces, 38 and 40, respectively. Screws 46 with gasketed-washers 48 are inserted through screw holes 44 to join housing 22 to other portions of illuminated address sign 20 as discussed further below. Internal cavity 42 may also include bendable tabs 50 for retaining lens 24, barrier 26, and EL light source 28 in the cavity. Of course, other mechanisms, e.g., clips, screw clamps, etc., may be used instead of bendable tabs 50 providing they non-destructively, removably retain lens 24, barrier 26, and EL light source 28 in the cavity. Housing 22 is generally a unitary construction formed from 20 gauge cold rolled steel, but may be a multi-piece construction. Housing 22 is generally fabricated so as to meet Canadian Standards Association (CSA) Specification 250 and Underwriter Laboratories (UL) Specification 1598.

Lens 24 includes a display side 52 and an internal side 54. Lens 24 is sized to cover opening 32 with display side 52 being exposed and visible through the opening and internal side 54 positioned in internal cavity 42. Display side 52 is typically used to display information, e.g., street address numbers, resident surnames, business names, estate names, etc. Typically, lens 24 is joined with housing 22 using a waterproof adhesive 55, e.g., a silicone epoxy, or similar to substantially seal opening 32. Lens 24 may be fabricated from an acrylic material as manufactured by Cyro Industries of West Paterson, N.J., or similar. Lens 24 is typically fabricated to meet UL Specification 94-HB.

Barrier 26 includes a front side 56 and a back side 58. Barrier 26 is positioned in internal cavity 42 and sized to cover lens 32 with front side 56 in contact with internal side 54 of lens 24 and back side 58 positioned in the internal cavity. In one embodiment, barrier 26 is approximately 0.010 to 0.050 inches in thickness. Barrier 26 is typically a flame-retardant, polycarbonate sheet as manufactured by GE Plastics of Pittsfield, Mass., or similar.

Electroluminescent light source 28 is generally positioned in internal cavity 42 adjacent and/or in contact with back side 58 of barrier 26. EL light source 28 is typically sized to cover lens 24. A typical EL light source 28 is one manufactured by Novatech Electro-Luminescent, Inc. of Chino, Calif., or similar. Wires 60 are joined with and extend from EL light source 28 and are used to connect the light source to a power source. Wires 60 are typically selected so as to meet UL Spec 1007 and include those manufactured by Alpha Wire of Elizabeth, N.J., or similar. Heatshrinks (not shown) used typically meet UL Spec 224, e.g., as manufactured by Gardner Bender of Milwaukee, Wis., or similar. Wire Connectors (not shown) typically meet UL Spec 760R, e.g., as manufactured by Gardner Bender of Milwaukee, Wis., or similar. In alternative embodiments, non-electroluminescent light sources may be utilized providing they provide a uniform plane of non-refractive light, have a low power draw, generate minimal heat, and are not subject to catastrophic failure.

Illuminated address sign 20 also typically includes a back plate 62, which is removably joined to housing 22 to enclose lens 24, flame-retardant barrier 26, and EL light source 28 within internal cavity 42. Similar to housing 22, back plate 62 also is generally an open box-type construction and includes first and second side walls, 64 and 66, respectively, top and bottom walls, 68 and 70, respectively, and a planar surface 72 formed between the walls. Side walls 64 and 66 include screw holes 74 that mate with screw holes 44 and planar surface 72 includes a center hole 75 and one or more mounting holes 76 for receiving mounting screws 78. Back plate 62 is generally a unitary construction formed from 20 gauge cold rolled steel, but may be a multi-piece construction. Back plate 62 is generally fabricated so as to meet Canadian Standards Association (CSA) Specification 250 and Underwriter Laboratories (UL) Specification 1598. In alternative embodiments, back plate 62 may be integral to housing 22 or joined with housing 22 using hinges or similar.

Illuminated address sign 20 and EL light source 28 are typically energized by connecting wires 60 to 110-120 volt AC current via an electric box (not shown) or similar current source. Typically, a photocell circuit 80 with a photocell sensor portion 82 is mounted in housing 22 (with the sensor portion extending from top surface 38) and wires 60 are run through the photocell circuit before connecting with EL light source 28. Photocell circuit 80 prevents activation of illuminated address sign 20 and EL light source 28 during daylight hours thereby extending the life of the sign and reducing the power draw. A typical photocell circuit 80 and sensor portion 82 is one manufactured by National State Industries of Kowloon, Hong Kong, or similar.

Installation of illuminated address sign 20 is achieved by first attaching a fixture bracket 84 to an electrical box or other mounting surface (not shown). Next, a ground wire (not shown) is attached to the electrical box or other mounting surface and a ground nut 86 joined with fixture bracket 84. A threaded mounting post 88, which also serves as a conduit for wires 60, is then screwed into fixture bracket 84 approximately halfway. Next, wires 60, which extend from mounting post 88, are connected to the appropriate wires, e.g., black to black and white to white, at a power source (not shown) using wire connectors (not shown) as discussed above. Back plate 62 is next attached the electrical box or mounting surface by allowing mounting post 88 to protrude through center hole 75 and using a mounting ring 90 to secure the mounting post to the back plate. Then, mounting nuts 92 are added on each end of mounting post 88 to ensure the mounting post is securely attached to back plate 62. Finally, housing 22 and back plate 62 are joined to one another using screws 46.

The present invention offers a plurality of benefits and advantages over prior art designs. Electroluminescent light provides a uniform plane of light unlike traditional incandescent backlighting, which only illuminates the “hot” spots on a sign. Electroluminescent light also is non-refractive light that is able to cut through fog and smoke, which helps firefighter and police locate an address quickly. In contrast, a traditional incandescent backlight home address sign emits refractive light that bounces off fog or smoke and does not penetrate like an EL light source. Finally, an electroluminescent address sign according to at least one embodiment of the present invention meets UL Standard 1598, which is a new standard for electroluminescent lighting.

Although the invention has been described and illustrated with respect to exemplary embodiments thereof, it should be understood by those skilled in the art that the foregoing and various other changes, omissions and additions may be made therein and thereto, without parting from the spirit and scope of the present invention.

What is claimed is:

1. An illuminated address sign comprising:
a housing;
a lens positioned in said housing;
an at least semi-transparent, flame-retardant barrier positioned in said housing adjacent said lens; and
an electroluminescent light source positioned in said housing adjacent said flame-retardant barrier so as to sandwich said flame-retardant barrier between said lens and said electroluminescent light source.

2. An illuminated address sign according to claim 1, said housing further comprising a front surface having an opening, first and second side surfaces, top and bottom surfaces, and an open internal cavity opposite said front surface.

3. An illuminated address sign according to claim 2, said lens further comprising a display side and an internal side, said lens sized to cover said opening, said display side being exposed through said opening, and said internal side positioned in said internal cavity.

4. An illuminated address sign according to claim 2, said at least semi-transparent flame-retardant barrier further comprising a front side and a back side, said barrier positioned in said internal cavity and sized to cover said lens, said front side in contact with said internal side and said back side positioned in said internal cavity.

5. An illuminated address sign according to claim 4, said electroluminescent light source positioned in said internal cavity adjacent said back side and sized to cover said lens, said light source including wires for connecting to a power source.

6. An illuminated address sign according to claim 2, further comprising a back plate removably joined to said housing to enclose said lens, said flame-retardant barrier, and said electroluminescent light source within said internal cavity.

7. An illuminated address sign according to claim 1, wherein said lens displays information.

8. An illuminated address sign according to claim 1, wherein said electroluminescent light source provides a uniform plane of non-refractive light light.

9. An illuminated address sign according to claim 1, wherein said flame-retardant barrier is a polycarbonate barrier.

10. An illuminated address sign according to claim 1, further comprising means for energizing said electroluminescent light source.

11. An illuminated address sign according to claim 1, further comprising a photocell circuit for controlling activation of said electroluminescent light source.

12. An illuminated address sign comprising:
a housing including a front surface having an opening, first and second side surfaces, top and bottom surfaces, and an internal cavity opposite said front surface;
a lens including a display side and an internal side, said lens sized to cover said opening, said display side being exposed through said opening, and said internal side positioned in said internal cavity;
an at least semi-transparent flame-retardant barrier having a front side and a back side, said barrier positioned in said internal cavity and sized to cover said lens, said front side in contact with said internal side and said back side and said back side positioned in said internal cavity;
an electroluminescent light source positioned in said internal cavity adjacent said back side and sized to cover said lens, said light source including wires for connecting to a power source; and
a back plate removably joined to said housing to enclose said lens, said flame-retardant barrier, and said electroluminescent light source within said internal cavity.

13. An illuminated address sign according to claim 12, wherein said lens is joined with said housing to substantially seal said opening.

14. An illuminated address sign according to claim 12, wherein said lens displays information.

15. An illuminated address sign according to claim 12, wherein said electroluminescent light source provides a uniform plane of non-refractive light.

16. An illuminated address sign according to claim 12, wherein said flame-retardant barrier is a polycarbonate barrier.

17. An illuminated address sign according to claim 12, further comprising a photocell circuit for controlling activation of said electroluminescent light source.

18. An illuminated address sign comprising:
a housing;
a lens positioned in said housing;
an at least semi-transparent flame-retardant barrier, said barrier positioned in said housing adjacent said lens;
means for providing a non-refractive, uniform plane of light, said means positioned in said housing adjacent said flame-retardant barrier so as to sandwich said flame-retardant barrier between said lens and said means for providing a non-refractive, uniform plane of light; and
a back plate removably joined to said housing to enclose said lens, said flame-retardant barrier, and said means for providing a non-refractive, uniform plane of light within said housing.

19. An illuminated address sign according to claim 18, wherein said means for providing a non-refractive, uniform plane of light is an electroluminescent light source.

20. An illuminated address sign according to claim 18, wherein said lens displays information.

21. An illuminated address sign according to claim 18, wherein said flame-retardant barrier is a polycarbonate barrier.

22. An illuminated address sign according to claim 18, further comprising means for energizing said electroluminescent light source.

23. An illuminated address sign according to claim 18, further comprising a photocell circuit for controlling activation of said electroluminescent light source.
